(19) United States
(12) Patent Application Publication
(10) Pub. No.: US 2025/0238004 A1
(43) Pub. Date: Jul. 24, 2025

(54) NEURAL NETWORK ADAPTIVE CONTROL FOR SOURCE MEASURE UNITS

(71) Applicant: Keithley Instruments, LLC, Solon, OH (US)

(72) Inventor: Daniel Mesenger, Reminderville, OH (US)

(21) Appl. No.: 18/983,044

(22) Filed: Dec. 16, 2024

Related U.S. Application Data
(60) Provisional application No. 63/622,221, filed on Jan. 18, 2024.

(51) Int. Cl. G05B 13/02

(52) U.S. Cl. CPC G05B 13/027

(57) ABSTRACT

A test and measurement instrument includes a voltage source and a sense resistor, one or more neural networks, and one or more processors configured to execute code that causes the one or more processors to generate a control signal to control a voltage or current to send to a user load as a device under test (DUT) and a reference model, send the control signal, an output from the user load, and an output from the reference model based upon the control signal to the one or more neural networks and receive an output adjustment, and adjust the control signal with the output adjustment to cause the user load to perform like the reference model.

### CROSS-REFERENCE TO RELATED APPLICATIONS

This disclosure is a non-provisional of and claims benefit from U.S. Provisional Application No. 63/622,221, titled “NEURAL NETWORK ADAPTIVE CONTROL FOR SOURCE MEASURE UNITS,” filed on Jan. 18, 2024, the disclosure of which is incorporated herein by reference in its entirety.

### TECHNICAL FIELD

This disclosure relates to source measure units (SMU), and more particularly source measure units using neural networks.

### BACKGROUND

Source measure unit (SMU) instruments precisely source voltage or current to a device under test (DUT), and simultaneously measure voltage and/or current. In a single output stage design, the output stage delivers the voltage across the load and the sense resistor, R_{S}. The load in many cases comprises a device under test (DUT), and the dimensions, including resistance, of the load are unknown. The sense resistor allows the SMU to be used to measure or force current.

One problem with traditional analog based control loops in an SMU product is that users cannot make changes to the controller at runtime since the controller is built into the hardware. This problem of not making changes has been solved with digital implementation of SMU control loops 10 as shown as a simplified version in FIG. 1. Digital control loops allow the controller to be changed at runtime. The digital control loop generally involves some type of programmable control circuit 12 and sets the voltage or current to a target setpoint. Analog-to-digital converters (ADCs) measure the output voltage and current and the digital control loop drives a digital-to-analog converter (DAC) until the output voltage and/or current reaches the respective desired levels. The digital control loop receives the desired target value and adjusts the voltage provided by the DAC. Generally, these digital control types of controllers require the user to manually enter information about their device under test (DUT) through a user interface such as user interface 14.

### BRIEF DESCRIPTION OF THE DRAWINGS

FIG. 1 shows an embodiment of a source measure unit (SMU).

FIG. 2 shows a block diagram of an SMU controller in an embodiment of an SMU that includes a reference model and at least one neural network.

FIG. 3 shows a block diagram of an embodiment of a predictor neural network.

FIG. 4 shows an example of a series of control signals used to train a predictor network.

FIG. 5 shows a block diagram of an embodiment of an SMU controller having a predictor neural network and an adaptive control network.

FIG. 6 shows a flowchart of an embodiment of a method of adjusting a control signal from a source measure unit.

FIG. 7 shows block diagram of an embodiment of an adaptive control network.

### DESCRIPTION

The embodiments here leverage the existence of programmable circuits loops that allow the controller to be changed at runtime. Changing the controller at runtime allows for the possibility of optimizing the control loop for a particular user load. The embodiments here involve a test and measurement instrument, typically a source measure unit (SMU), and method that utilizes neural networks to learn about the system dynamics of a user load. The instrument adjusts the control signal to compensate for the unique user load at runtime. The term “control signal” as used here means the signal generated by the programmable circuit to cause the SMU to generate a voltage or current to be send to the user load. The term “user load” means the user's device under test (DUT).

The term “processor” as used herein refers to the programmable circuit. This discussion refers to the programmable circuit as a processor or a controller, which may include a general-purpose processor, digital signal processor, an Application Specific Integrated Circuit (ASIC), a field-programmable gate array (FPGA), or any other type of controller that can perform those functions.

The embodiments here provide a benefit in that an SMU has the capability to learn how to optimize its own performance on any user load without requiring the user to manually input any information about the user load. The user may be required to inform the SMU of a range of inputs for the user load and to allow the SMU a moment to briefly output a signal that allows the SMU to learn the system dynamics of the user load. Upon completion of that learning process, the SMU continuously attempts to optimize its performance for the user load.

As used here “optimal performance” means matching the performance of a reference model for which the SMU controller was designed to control. The type of controller used is independent of the neural network adaptive control. The controller is designed to optimally control the reference model. However, inevitable differences between the reference model and the user load occur due to nonlinearities and errors in the reference model. Generally, the neural network looks at the control signal from the SMU controller, the output of the reference model, and the current output of the user load to create an addition to the control signal intended to force the user load to behave like the reference model.

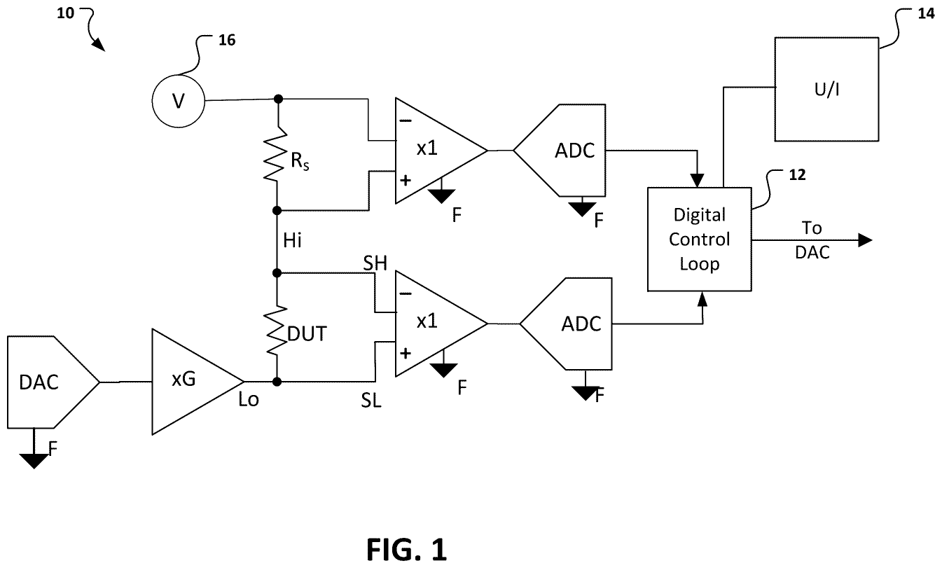

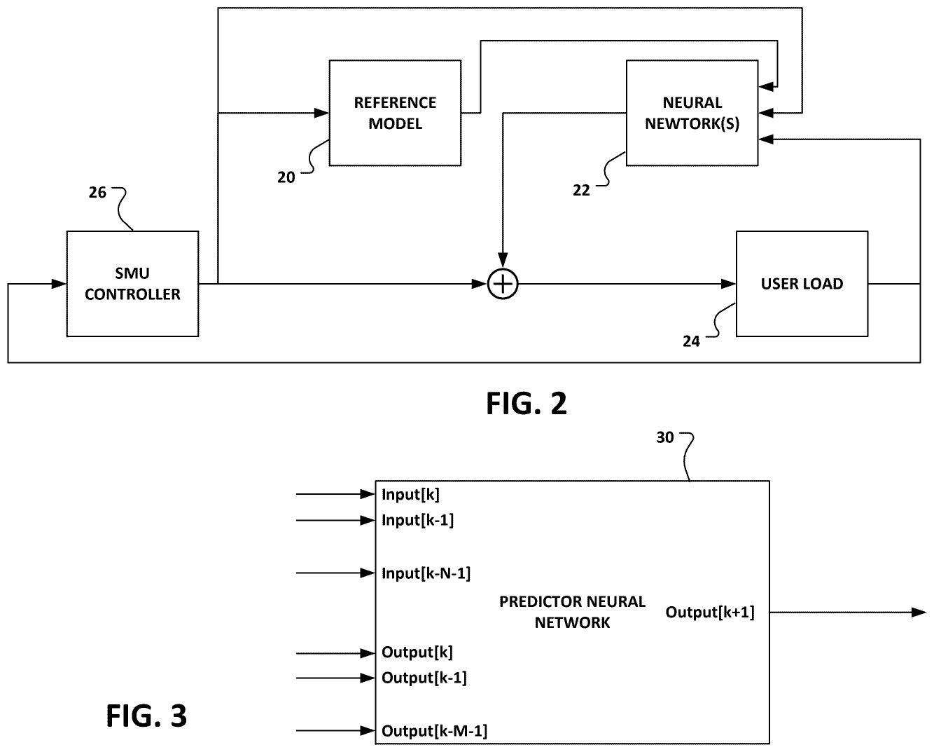

FIG. 2 illustrates the SMU controller, the reference model, the neural network, and the user load. The SMU controller 26 is an embodiment of the digital control loop 12 of the SMU of FIG. 1. The controller 12 operates to generate control signals for the voltage source 16.

This discussion separates the SMU control function from the neural networks 22, referring to the SMU controller 26 and the neural networks 22 as separate components. Physically, the SMU controller 26 and the neural networks 22 may reside on a same device, such as an FPGA, or within a same digital signal processor (DSP), or ASIC. As mentioned above, the SMU controller 26, analogous to the digital control loop 12 of FIG. 1, is designed to control the reference model 20. The reference model 20 corresponds to an “ideal” load, and the discussion here may refer to the responses of the reference model 20 as “desired” outputs or responses. The control signal from the SMU controller 26 goes to reference model 20 and the user load 24. The neural network(s) 22 takes output of reference model 20, and the user load 24, as well as the control signal, and provides an output to adjust the control signal to cause the user load 24 to behave like reference model 20.

As discussed in more detail later, the neural network that generates the adjustment output comprises an adaptive control neural network. The adaptive control neural network continuously trains by back propagating the error in its output through the network to update its tunable parameters. However, one typically cannot know the error in the output of the neural network by directly observing the output of the control signal. While the possibility exists that one could wait for the user load to respond, waiting for a response may cause the system to run much more slowly than desired. The issue of not being able to wait gives rise to a need for a second neural network that can accurately predict the output of the user load based upon the input control signal, even though the second predictor neural network is technically optional.

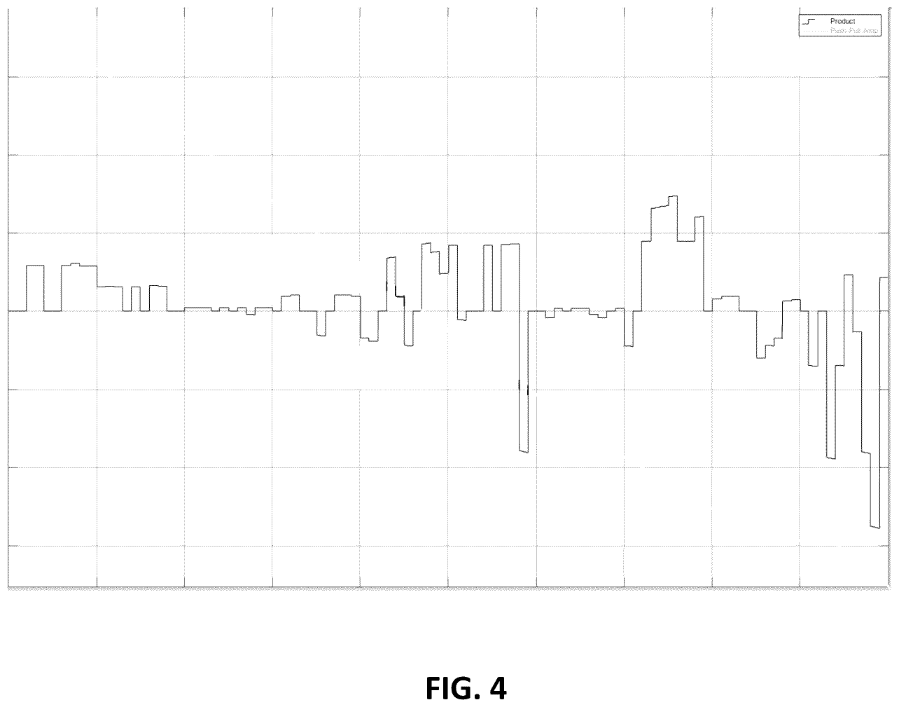

As shown in FIG. 3, the second neural network, referred to here as the predictor neural network 30, receives the last N inputs to the user load and the last M outputs from the user load corresponding to the N inputs. The discussion here may also refer to the N inputs and the M outputs as the state of the user load. The predictor neural network 30 has undergone training to predict the next output of the user load based upon the current signal and the current state of the user load.

More specifically with regard to the predictor neural network training, the predictor neural network 30 trains once for any given user load. The SMU controller generates a randomized control signal to input to the user load. During the training process, the previous N inputs and the corresponding M outputs to the N inputs are paired with the control signal and the resulting output from the user load. The inputs, outputs, control signal and resulting output create a training data set for the predictor neural network. Training the predictor neural network results in the predictor neural network predicting the next output of the user load by looking at the previous N inputs and M outputs.

The randomized control signal has properties of the actual control signal. Accordingly, if the actual control signal is likely to consist of functions like a step, ramp, exponential, quadratic, or other function, the training signal must also have these function properties. A randomized training control signal can be generated by combining randomized base functions in the following ways: (1) generating a function that is randomly scaled, periodically, of each function type (step, ramp, exponential, etc.); (2) randomly selecting one of the base functions, periodically, in a many to one multiplexer; and (3) periodically and randomly scaling the output such that the output is within a predefined range that is safe for the DUT. The randomized training control signal can be generated using other ways as well. FIG. 4 illustrates an example randomized control signal as described herein.

Once the predictor neural network has undergone training for a particular user load, without further training, the system can be used to predict how any control signal affects the user load by feeding the user load's current state in the form of previous inputs and outputs and an input to the predictor neural network.

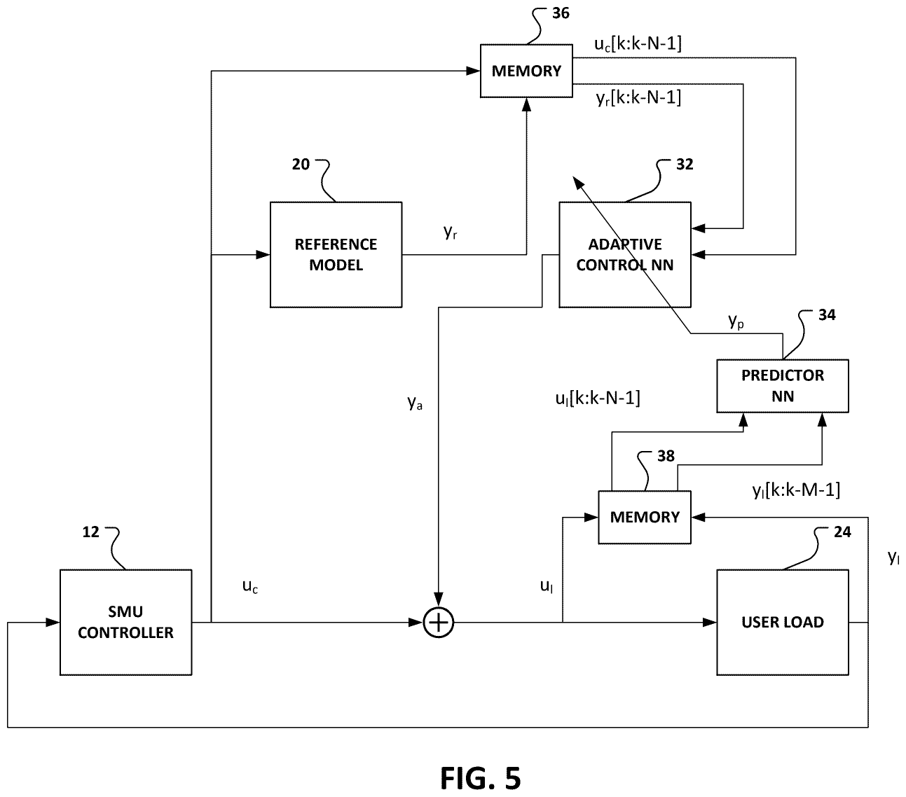

FIG. 5 shows a more detailed embodiment of the SMU controller, neural networks, and user load. Regarding the signals annotation, the letter “u” indicates a variable control signal, and “y” indicates the outputs. The SMU controller 26 generates the control signal u_{c}. The adjusted output “yₐ” from the adaptive control neural network 32 adjust the control signal u_{c}. to produce the control signal “uₗ” sent to the user load 24 and memory 38. The adjustment typically comprises an addition to the control signal. The user load output “yₗ” also gets stored in the memory 38. The predictor neural network 34 receives a predetermined number of user load control signals and user load outputs from memory 38. The predictor neural network 34 then produces the predicted output “yₚ” and provides the predicted output to the adaptive control neural network 32. The adaptive control neural network 32 also receives a set of reference model outputs from reference model 20, and a set of the controller generated control signals stored in memory 36. The adaptive control neural network 32 then produces the adjustment output “yₐ” to be added to the controller generated control signal. The adjustment allows the SMU to adjust its performance based upon the user load 24 to make the user load 24 behave like the reference model 20 for which the SMU controller 26 was designed.

The adaptive control neural network trains continuously during operation of the SMU. Continuous training means that, at each timestep, the system backpropagates the error in its output through the neural network to update the tunable parameters of the adaptive control neural network. The error in the output of the adaptive control neural network cannot be known by directly observing the output of the control signal. When placing the full system together, the predictor neural network can be used to evaluate the loss the function for training of the adaptive control neural network.

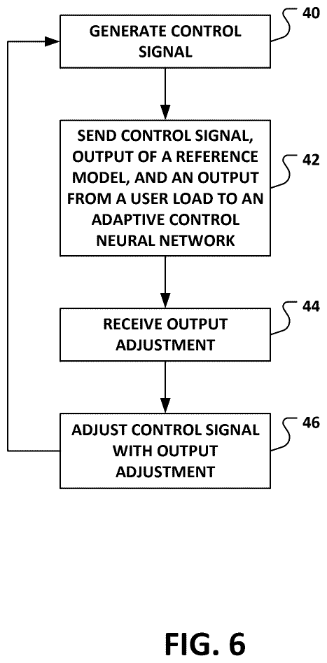

FIG. 6 shows a flowchart of an embodiment of the control signal adjustment process. The SMU controller generates a control signal at 40 and sends the control signal to the adaptive control neural network at 42. The controller causes the predictor neural network to send the output from the user load, and the output from the reference model to the adaptive control neural network also at 42. The adaptive control network generates the output adjustment received by the controller at 44. The controller adjusts the control signal at 46. This process repeats as needed until the user disconnects the load or otherwise ends the process.

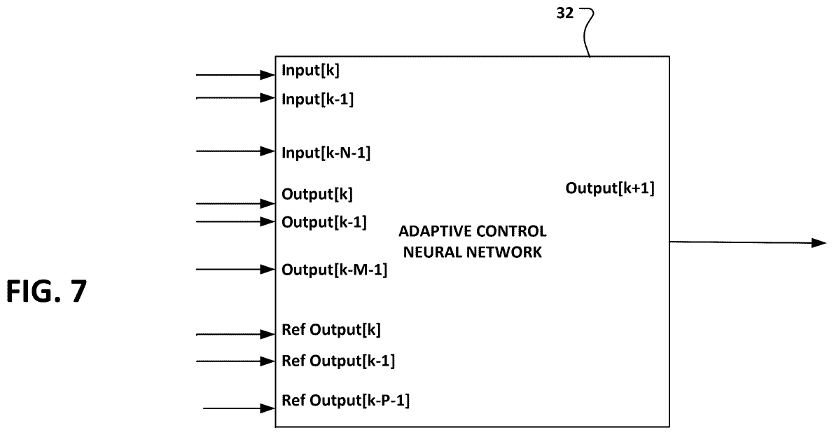

FIG. 7 illustrates an embodiment of an adaptive control neural network 32. The adaptive control neural network 32 adjusts the control signal, such as adding to the controller generated control signal so that the combined control signal makes the user load behave the same as the reference model. The inputs to the adaptive control neural network 32 are similar to the predictor neural network with the addition of a window having a size P of outputs from the reference model 20 of FIG. 5. The output of the adaptive control neural network comprises an addition/adjustment to the controller-generated control signal.

The adaptive control neural network trains “online,” meaning that every time the adaptive control neural network produces an output, the error between the actual output and the desired output trains the adaptive control neural network by backpropagating the error to adjust the tunable parameters of the adaptive control network. Using the predictor neural network, the system can predict how the control signal affects the user load. Consequently, the output of the adaptive control neural network is added to the output of the controller and the combined signal is forwarded through the predictor neural network. Accordingly, the system has a prediction of how the combined signal affects the user load. As mentioned above, the goal of the adaptive control neural network is to make the user load act the same way as the reference model. Therefore, the error in the adaptive control neural network can be calculated as the absolute value of the difference between the predicted output and the output of the reference model. The result of the training is an adaptive control neural network that attempts to add to the control signal in a way that makes the user load behave the same as the reference model.

$$error = \vert {y}_{p} - {y}_{r} \vert$$

In this manner, an SMU having a digital control capability can use neural networks to adjust the control signals from the SMU controller to cause the user load to act like the reference model. The SMU optimizes its performance for each user load, and the user only has to provide a range of inputs that result in a safe range of outputs for the user load.

Aspects of the disclosure may operate on a particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, field programmable gate arrays (FPGAs), and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, read only memory (ROM), Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement instrument, comprising: a voltage source and a sense resistor; one or more neural networks; and one or more processors configured to execute code that causes the one or more processors to: generate a control signal to control a voltage or current to send to a user load as a device under test (DUT) and a reference model; send the control signal, an output from the user load, and an output from the reference model based upon the control signal to the one or more neural networks and receive an output adjustment; and adjust the control signal with the output adjustment to cause the user load to perform like the reference model.

Example 2 is the test and measurement instrument of Example 1, wherein the one or more neural networks comprises at least an adaptive control neural network.

Example 3 is the test and measurement instrument of Example 2, wherein the one or more neural networks comprises a predictor neural network.

Example 4 is the test and measurement instrument of Example 3, wherein the predictor neural network is configured to take the control signal as an input and at least one output from the user load, and produce a predicted output from the user load based upon the control signal, the predicted output to be used as the output from the user load for the adaptive control neural network.

Example 5 is the test and measurement instrument of Example 3, wherein the at least one control signal comprises a predetermined number of previous control signals and corresponding number of previous outputs from the user load.

Example 6 is the test and measurement instrument of Example 4, wherein the adaptive control neural network trains continuously using a difference between the predicted output and the output of the reference model.

Example 7 is the test and measurement instrument of Example 3, wherein the one or more processors are further configured execute code that causes the one or more processors to train the predictor neural network.

Example 8 is the test and measurement instrument of Example 7, wherein the code that causes the one or more processors to train the predictor neural network comprises code that causes the one or more processors to: access a predetermined number of previous inputs to the user load and outputs from the user load corresponding to the predetermined number of previous inputs; generate a randomized control signal; input the randomized control signal to the user load; pair an output from the user load in response to the randomized control signal with the predetermined number of previous inputs and corresponding number of previous outputs to create a training set; and use the training set to train the predictor neural network.

Example 9 is the test and measurement instrument of Example 8, wherein the code that causes the one or more processors to generate a randomized control signal comprises scaling the randomized control signal to cause the output from the user load to be within a safe range for the user load.

Example 10 is the test and measurement instrument of any of Examples 1 through 9, further comprising one or more memories to store one or more of outputs of the reference model, control signals, user loads, and predicted outputs.

Example 11 is the test and measurement instrument of any of Examples 1 through 10, wherein the one or more neural networks comprise code executed by the one or more processors.

Example 12 is a method of automatically adjusting a control signal from a source measure unit to a user load, comprising: generating a control signal to control a voltage or current to send to a user load as a device under test (DUT) and a reference model; sending the control signal, an output from the user load, and an output from a reference model based upon the control signal to an adaptive control neural network and receiving an output adjustment; and adjusting the control signal with the output adjustment to cause the user load to perform like the reference model.

Example 13 is the method of Example 12, further comprising generating the output from the user load by sending at least one control signal as an input and at least one output from the user load to a predictor neural network, and receiving a predicted output from the user load based upon the control signal to be used as the output from the user load sent to the adaptive control neural network.

Example 14 is the method of Example 13, wherein the at least one control signal comprises a predetermined number of previous control signals and corresponding number of previous outputs from the user load.

Example 15 is the method of Example 13, further comprising continuously training the adaptive control neural network using a difference between the predicted output and the output of the reference model.

Example 16 is the method of Example 13, further comprising training the predictor neural network.

Example 17 is the method of Example 16, wherein training the predictor neural network comprises: accessing a predetermined number of previous inputs to the user load and a corresponding number of previous outputs; generating a randomized control signal; inputting the randomized control signal to the user load; pairing an output from the user load in response to the randomized control signal with the predetermined number of previous inputs and corresponding number of previous outputs to create a training set; and using the training set to train the predictor neural network.

Example 18 the method of Example 17, wherein generating a randomized control signal comprises scaling the randomized control signal to cause the output from the user load to be within a safe range for the user load.

Example 19 is the method of any of Examples 12 through 18, further comprising storing one or more of outputs of the reference model, control signals, outputs from user loads, and any predicted outputs.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

The invention claimed is:

1. A test and measurement instrument, comprising:
a voltage source and a sense resistor;
one or more neural networks; and
one or more processors configured to execute code that causes the one or more processors to:
generate a control signal to control a voltage or current to send to a user load as a device under test (DUT) and a reference model;
send the control signal, an output from the user load, and an output from the reference model based upon the control signal to the one or more neural networks and receive an output adjustment; and
adjust the control signal with the output adjustment to cause the user load to perform like the reference model.

2. The test and measurement instrument as claimed in claim 1, wherein the one or more neural networks comprises at least an adaptive control neural network.

3. The test and measurement instrument as claimed in claim 2, wherein the one or more neural networks comprises a predictor neural network.

4. The test and measurement instrument as claimed in claim 3, wherein the predictor neural network is configured to take the control signal as an input and at least one output from the user load, and produce a predicted output from the user load based upon the control signal, the predicted output to be used as the output from the user load for the adaptive control neural network.

5. The test and measurement instrument as claimed in claim 3, wherein the at least one control signal comprises a predetermined number of previous control signals and corresponding number of previous outputs from the user load.

6. The test and measurement instrument as claimed in claim 4, wherein the adaptive control neural network trains continuously using a difference between the predicted output and the output of the reference model.

7. The test and measurement instrument as claimed in claim 3, wherein the one or more processors are further configured execute code that causes the one or more processors to train the predictor neural network.

8. The test and measurement instrument as claimed in claim 7, wherein the code that causes the one or more processors to train the predictor neural network comprises code that causes the one or more processors to:
access a predetermined number of previous inputs to the user load and outputs from the user load corresponding to the predetermined number of previous inputs;
generate a randomized control signal;
input the randomized control signal to the user load;
pair an output from the user load in response to the randomized control signal with the predetermined number of previous inputs and corresponding number of previous outputs to create a training set; and
use the training set to train the predictor neural network.

9. The test and measurement instrument as claimed in claim 8, wherein the code that causes the one or more processors to generate a randomized control signal comprises scaling the randomized control signal to cause the output from the user load to be within a safe range for the user load.

10. The test and measurement instrument as claimed in claim 1, further comprising one or more memories to store one or more of outputs of the reference model, control signals, user loads, and predicted outputs.

11. The test and measurement instrument as claimed in claim 1, wherein the one or more neural networks comprise code executed by the one or more processors.

12. A method of automatically adjusting a control signal from a source measure unit to a user load, comprising:
generating a control signal to control a voltage or current to send to a user load as a device under test (DUT) and a reference model;
sending the control signal, an output from the user load, and an output from a reference model based upon the control signal to an adaptive control neural network and receiving an output adjustment; and
adjusting the control signal with the output adjustment to cause the user load to perform like the reference model.

13. The method as claimed in claim 12, further comprising generating the output from the user load by sending at least one control signal as an input and at least one output from the user load to a predictor neural network, and receiving a predicted output from the user load based upon the control signal to be used as the output from the user load sent to the adaptive control neural network.

14. The method as claimed in claim 13, wherein the at least one control signal comprises a predetermined number of previous control signals and corresponding number of previous outputs from the user load.

15. The method as claimed in claim 13, further comprising continuously training the adaptive control neural network using a difference between the predicted output and the output of the reference model.

16. The method as claimed in claimed in claim 13, further comprising training the predictor neural network.

17. The method as claimed in claim 16, wherein training the predictor neural network comprises:
accessing a predetermined number of previous inputs to the user load and a corresponding number of previous outputs;
generating a randomized control signal;
inputting the randomized control signal to the user load;
pairing an output from the user load in response to the randomized control signal with the predetermined number of previous inputs and corresponding number of previous outputs to create a training set; and
using the training set to train the predictor neural network.

18. The method as claimed in claim 17, wherein generating a randomized control signal comprises scaling the randomized control signal to cause the output from the user load to be within a safe range for the user load.

19. The method as claimed in claim 12, further comprising storing one or more of outputs of the reference model, control signals, outputs from user loads, and any predicted outputs.
